(19) United States
(12) Patent Application Publication
(10) Pub. No.: US 2007/0273532 A1
(43) Pub. Date: Nov. 29, 2007

(54) RFID tag for conductive surface

(75) Inventor: Philippe Martin, Beaune (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tagsys SAS, La Penne-Sur Huveaune (FR)

(21) Appl. No.: 11/801,681

(22) Filed: May 10, 2007

Related U.S. Application Data
(60) Provisional application No. 60/801,199, filed on May 17, 2006.

(51) Int. Cl. G08B 13/14

(52) U.S. Cl. 340/572.7; 340/572.8

(57) ABSTRACT

An RFID tag is disclosed for application to a conductive surface. The RFID tag includes an insulating substrate and a first conductive plate provided on the insulating substrate such that the first plate and the conductive surface form a first capacitor, an antenna provided on the substrate and connected to the first capacitor to form a resonant circuit, at least when the tag is applied to the conductive surface, and an integrated circuit connected to the resonant circuit. Preferably, the RFID tag includes a second conductive plate on the substrate, the second plate and conductive surface forming a second capacitor. The two capacitors may be connected in series. A method of applying an RFID tag to a conductive surface is also disclosed.

### CROSS-REFERENCE TO RELATED APPLICATIONS

This application claims the benefit of the filing date of U.S. Provisional Patent Application No. 60/801,199 filed May 17, 2006, the disclosure of which is hereby incorporated herein by reference.

### BACKGROUND OF THE INVENTION

The present invention relates to radio frequency identification (RFID) tags. In particular the present invention relates to RFID tags suitable for application to conductive surfaces.

An RFID tag is read via the principle of electromagnetic communication wherein an interrogator containing a transmitter generates an electromagnetic signal that is transmitted via an antenna associated with the interrogator to an antenna associated with the tag. In a passive tag the antenna receives a portion of the transmitted energy and through a rectifier generates a dc power supply for operating a reply generation circuit. The reply generation circuit encodes information stored in the tag into an electromagnetic reply signal that is radiated by the antenna. The radiated signal is received by the interrogator antenna and the information is decoded by the interrogator.

One problem with application of an RFID tag to a conductive surface is that operation of the tag is often impaired or impossible because the interrogating signal or field is absorbed or dissipated by the conductive surface in the form of eddy currents. This problem is more pronounced in the case of a passive RFID tag because the tag possesses no energy source of its own and relies for its operation on power extracted from the interrogating signal or field.

### SUMMARY OF THE INVENTION

The present invention provides RFID tags that may be applied to conductive surfaces. RFID tags according to the present invention are suitable for use with products having conductive surfaces such as metallic capsules or metallic caps or closures associated with containers. The containers may include vials, tubes or the like. The containers may be filled with sensitive, dangerous or high value contents such as pharmaceuticals, biological materials or chemicals wherein it is desirable to provide contactless or remote tagging or identification for such containers and their contents.

According to one aspect of the present invention there is provided an RFID tag suitable for application to a conductive surface, said RFID tag including:

an insulating substrate;

a first conductive plate provided on said insulating substrate such that said first plate and said conductive surface form a first capacitor;

an antenna provided on said substrate and connected to said first capacitor to form a resonant circuit; and

an integrated circuit connected to said resonant circuit.

A second conductive plate may be included on the substrate such that the second plate and the conductive surface form a second capacitor, the second capacitor being connected to the resonant circuit. The first conductive plate preferably is substantially penannular. The first and second capacitors may be connected in series via the conductive surface. The second conductive plate preferably is substantially penannular. The antenna may comprise a spiral conductor. The spiral antenna may be interposed between the first and second plates.

The RFID tag preferably has dimensions suitable for fixing to a relatively small conductive surface such a metallic cap of a small container. The area of the tag preferably comprises a substantial portion of the area of the conductive surface. In one embodiment the area of the tag may comprise at least 50% or more of the area of the conductive surface. In a preferred embodiment the RFID tag may have an outer diameter approximately 8 to 15 mm and a thickness comparable to the substrate on which it is formed. A cap of a small container may not significantly absorb or dissipate the electromagnetic field associated with the interrogating signal.

According to a further aspect of the present invention there is provided a method of applying an RFID tag to a conductive surface, said method including:

providing an insulating substrate on said conductive surface;

providing a first conductive plate on said insulating surface such that said first plate and said conductive surface form a first capacitor;

providing an antenna on said substrate and connecting said antenna to said first capacitor to form a resonant circuit at least when said tag is applied to said conductive surface; and

connecting an integrated circuit to said resonant circuit.

### BRIEF DESCRIPTION OF THE DRAWINGS

A preferred embodiment of the present invention will now be described with reference to the accompanying drawings wherein:

FIG. 1 shows an RFID tag according to the present invention applied to a metallic cap of a container;

FIG. 2 shows a plan view of one embodiment of an RFID tag according to the present invention;

FIG. 3 shows a cross-sectional view of the RFID tag;

FIG. 4 shows an equivalent circuit of the RFID tag; and

FIG. 5 shows the circuit in a conventional form.

### DETAILED DESCRIPTION

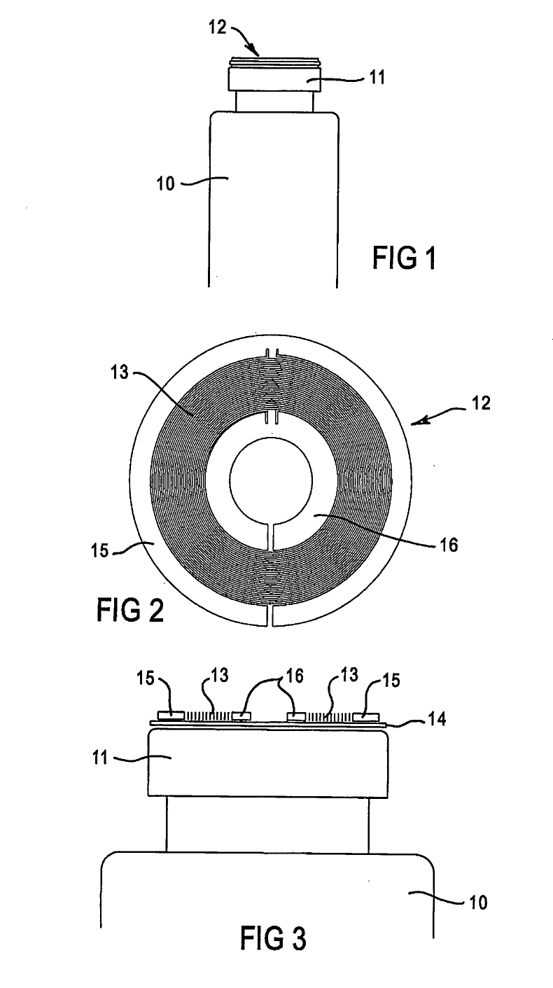

FIG. 1 shows container 10 with closure 11. Closure 11 includes metallic over capping such as aluminium. An RFID tag 12 according to the present invention is affixed to the metallic overcapping.

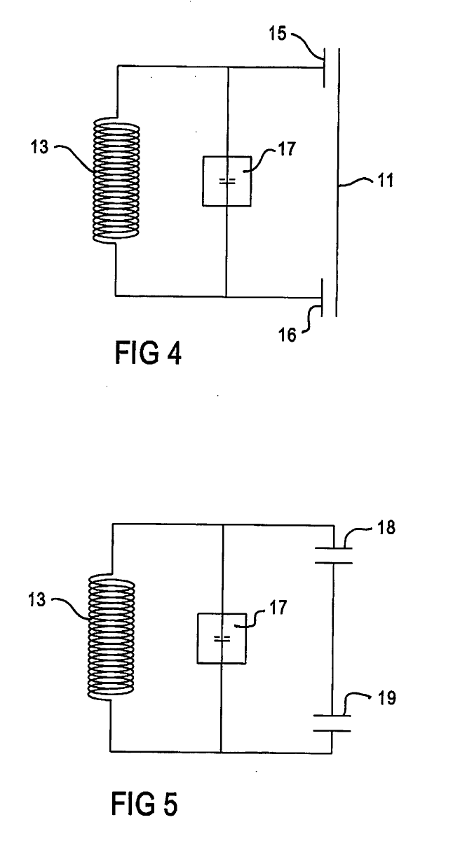

Referring to FIGS. 2 and 3, RFID tag 12 includes an antenna 13 comprising a spiral conductor formed on an insulating substrate 14. The substrate 14 may comprise a PCB or PET. The outer end of antenna 13 is connected to penannular capacitor plate 15 provided on substrate 14. The inner end of antenna 13 is connected to penannular capacitor plate 16 also provided on substrate 14. Capacitor plates 15, 16 are open or penannular to avoid creating magnetic short circuits or loops that may cause the electromagnetic field to dissipate. Antenna 13 and capacitor plates 15, 16 may be included on substrate 14 in any suitable manner and by any suitable means such as etching, printing, stamping or affixing. An integrated circuit (IC) chip 17 (refer FIGS. 4-5) is connected between capacitor plates 15, 16.

Referring to FIG. 4, the electrical circuit includes antenna 13 providing an inductance. Capacitor plate 15 provides one half of capacitor 18 (refer FIG. 5). The other half of capacitor 18 is provided by metallic closure 11, ie. the surface to which tag 12 is affixed. Capacitor plate 16 provides one half of capacitor 19. The other half of capacitor 19 is provided by metallic closure 11. Closure 11 additionally provides an effective series connection between capacitors 18 and 19. Capacitors 18, 19 and the inductance associated with antenna 13 form a resonant circuit that is connected in parallel with IC chip 17.

The frequency of the resonant circuit may be adjustable by varying the value of the inductance of antenna 13 and/or a capacitance associated with IC chip 17. The chip capacitance may be embedded on the chip or it may be a parasitic capacitance associated with the chip. Because the conductive surface associated with closure 11 forms a part of capacitors 18 and 19, it also forms part of the resonant circuit. This alleviates the problem wherein operation of prior art tags was impaired due to the electromagnetic radiation being absorbed by the conductive surface.

Finally, it is to be understood that various alterations, modifications and/or additions may be introduced into the constructions and arrangements of parts previously described without departing from the spirit or ambit of the invention.

1. An RFID tag suitable for application to a conductive surface, said RFID tag including:
an insulating substrate;
a first conductive plate provided on said insulating substrate such that said first plate and said conductive surface form a first capacitor;
an antenna provided on said substrate and connected to said first capacitor to form a resonant circuit at least when said tag is applied to said conductive surface; and
an integrated circuit connected to said resonant circuit.

2. An RFID tag according to claim 1 including a second conductive plate included on said substrate such that said second plate and said conductive surface form a second capacitor, said second capacitor being connected to said resonant circuit.

3. An RFID tag according to claim 2 wherein said first and second capacitors are connected in series via said conductive surface.

4. An RFID tag according to claim 1 wherein said first conductive plate is substantially penannular.

5. An RFID tag according to claim 2 wherein said second conductive plate is substantially penannular.

6. An RFID tag according to claim 1 wherein said antenna comprises a spiral conductor.

7. An RFID tag according to claim 1 wherein the area of said tag comprises a substantial portion of the area of said conductive surface.

8. A method of applying an RFID tag to a conductive surface, said method including:
providing an insulating substrate on said conductive surface;
providing a first conductive plate on said insulating surface such that said first plate and said conductive surface form a first capacitor;
providing an antenna on said substrate and connecting said antenna to said first capacitor to form a resonant circuit at least when said tag is applied to said conductive surface; and
connecting an integrated circuit to said resonant circuit.

9. A method according to claim 8 including providing a second conductive plate on said substrate such that said second plate and said conductive surface form a second capacitor, said second capacitor being connected to said resonant circuit.

10. A method according to claim 9 wherein said first and second capacitors are connected in series via said conductive surface.

11. A method according to claim 8 wherein said first conductive plate is substantially penannular.

12. A method according to claim 9 wherein said second conductive plate is substantially penannular.

13. A method according to claim 8 wherein said antenna comprises a spiral conductor.

14. A method according to claim 8 wherein the area of said tag comprises a substantial portion of the area of said conductive surface.
